(19) United States
(12) Patent Application Publication
(10) Pub. No.: US 2026/0285406 A1
(43) Pub. Date: Sep. 24, 2026

(54) Energy Absorption Member Comprising a Composite and a Metal Member

(71) Applicant: Zephyros, Inc., Romeo, MI (US)

(72) Inventors: Nuria Ignes I Mullol, Molsheim Cedex (FR); Amar Ali-Larnene, Molsheim Cedex (FR)

(21) Appl. No.: 19/472,347

(22) PCT Filed: Apr. 4, 2024
(86) PCT No.: PCT/EP2024/059199

§ 371 Date: Oct. 3, 2025

(30) Foreign Application Priority Data
Apr. 11, 2023 (EP) 23167410.2

(51) Int. Cl. B62D 21/15; B60K 1/04; B62D 25/02; H01M 50/242; H01M 50/249

(52) U.S. Cl. CPC B62D 21/157; B62D 25/025; H01M 50/242; H01M 50/249; B60K 1/04; H01M 2220/20

(57) ABSTRACT

The present invention relates to a system comprising: - a structural member of a vehicle and - a reinforcement member inserted into the structural member and comprising a hollow metal structure and a 3D-structure attached to the metal structure. The present invention further relates to a method to absorb energy, particularly impact energy.

The present invention relates to a system comprising:
a structural member of a vehicle and
a reinforcement member inserted into the structural member and comprising a hollow metal structure and a 3D-structure attached to the metal structure.

The present invention further relates to a method to absorb energy, particularly impact energy.

Electric vehicles comprise a battery, which needs special crash protection.

There is a constant need in the industry, particularly in the automotive industry, to provide a system and a method which absorbs energy, particularly impact energy, and which are able to withstand impact forces in order to protect the passengers and certain elements in a vehicle, like batteries.

The problem is attained with a system comprising:
a structural member of a vehicle and
a reinforcement member inserted into the structural member and comprising a hollow metal structure and a 3D-structure attached to the metal structure, wherein the hollow metal structure comprises at least one rib each rib having a folding section.

The disclosure regarding this subject matter also applies to the other subject matters and vice versa. Subject matters disclosed regarding this embodiment of the invention can also be included in other embodiments and vice versa.

The present invention relates to a system comprising a structural element of a vehicle, for example a rocker. The structural element is preferably an elongated structural element that comprises a hollow cavity and has a longitudinal axis. Preferably, the structural element is made from two parts, for example two shells, preferably each comprising flanges, which preferably extend along the longitudinal axis. The parts are connected, preferably welded, more preferably along theirs flanges. The structural element is preferably made from metal, preferably a sheet metal. The metal is preferably aluminum or steel. Preferably attached to the structural is a battery case. The battery case is preferably protected by the structural element of the vehicle.

The system further comprises a reinforcement member which is inserted into the structural member. This reinforcement member comprises a hollow metal structure and a 3D-structure attached to the hollow metal structure, preferably to its circumference, preferably to a portion of its circumference. The attachment can be made via an adhesive and/or a form- and/or a force-fit. The reinforcement member may comprise attachment means to attach it to the structural member.

The 3D-structure, which preferably absorbs energy, particularly impact-energy, is preferably made from a polymeric material, more preferably nylon and/or Polyamid, preferably Polyamid 6 and/or a metal material, for example aluminum or steel. According to a preferred embodiment, the 3D-strucutre is made of a composite material, preferably comprising multiple polymeric materials and/or a combination of one or more plastic materials and one or more metal materials. The 3D-structure may comprise at least a first layer. However, the member may comprise more than one layer, particularly two, three, four, six or eight layers. Preferred is an even or uneven number of layers. More preferred, two layers of the 3D-struture, whose three-dimensional elements are inserted into each other more preferably stacked, form one assembled unit, which is attached to the hollow metal structure. Preferably, each layer of the 3D-strucutre comprises a multitude of three-dimensional elements, wherein the three-dimensional elements of two layers are stacked into each other. Preferably, the three-dimensional elements comprise a rim or flange. Two layers can be connected at the rim and/or flanges. One end of each three-dimensional elements may be provided in a plane and the rest of each three-dimensional elements extends out of this plane. The three-dimensional elements are preferably hollow structures. The skilled person understands, that the plane need not be flat, but can be three-dimensional, for example curved.

In case the 3D-strucutre comprises more than one layer, for energy dissipation purposes,
the three-dimensional elements of the first layer are preferably inserted into the hollow three-dimensional elements of the second layer and/or vice versa and/or
the three-dimensional elements of the first layer are inserted into a hollow space provided between two or more three-dimensional elements of the second layer and/or vice versa.

During impact, preferably friction between the three-dimensional elements of two layers and/or elastic- and/or plastic deformation and/or tangential stress of the three-dimensional elements takes place, so that energy is dissipated. During the plastic deformation, preferably the cross section of three-dimensional elements and/or the openings of at least one layer is reversibly and/or irreversibly increased and/or decreased and/or the axial extension of the three-dimensional elements of one or both layers is reversibly and/or irreversibly reduced.

The three-dimensional elements preferably have a circular, an oval and/or a polygonal cross-section. The shape of the cross section may vary with the axial extension of the three-dimensional elements. One layer may have three-dimensional elements with different cross sections and/or different axial lengths. Preferably, the three-dimensional elements are tapered, preferably with a larger or the largest cross section in the plane in which the three-dimensional elements are interconnected. In case the three-dimensional elements are tapered, the angel of inclination may be constant around their entire circumference or not. The angel of inclination may further vary with the axial length of the three-dimensional element. The sidewall of the one or more three-dimensional element(s) of one layer may include one or more step(s). In case the sidewall is made of a laminate, not all layers of the laminate need to comprise the step(s).

Preferably the shape and/or the size of the cross-section of the three-dimensional elements, the axial extension, the length of the three-dimensional elements, the inclination of the sidewall and/or the pattern, which they are distributed over the plane of two adjacent layers differ within one layer or between two adjacent layers.

Preferably, the three-dimensional elements of the layers each have a sidewall and the sidewall of the three-dimensional elements of the first layer has, at least locally, a different shape and/or size than the sidewall of the three-dimensional elements of the second layer.

Each opening may have a circular, an oval and/or a polygonal cross-section.

Preferably at least one of the first or second layer comprises connecting means. Via these connecting means, for example an adhesive layer, the layer can be connected to the structure of a vehicle and/or two or more layers can be interconnected by connection means, preferably an adhesive layer.

Two layers can also be connected to each other by connection means prior to an impact or an energy absorption. These connection means can be for example an adhesive, e.g. an adhesive layer, a friction-form- and/or fore-fit, for example a snap-fit.

Two layers, particularly the first- and the second layer can be provided as a single piece, preferably as one moulded-piece.

According to another preferred embodiment of the present invention, the thickness of the sidewall of the three-dimensional elements of at least one layer is not constant.

According to the present invention, the system further comprises a hollow metal structure. The hollow metal structure is preferably a tube, preferably with a rectangular or square cross-section. The hollow metal structure can be an extruded part or a part made from bent sheet metal.

Preferably, the cross section of the hollow metal structure is square or rectangular. Preferably the shape of the cross section of the hollow metal structure is adapted to the shape of the structural ember of the vehicle. Preferably, the hollow metal structure has two sidewall, a first end and a second end. The sidewalls and the first and second end are preferably the perimeter of a hollow metal structure with a rectangular cross section. Preferably the sidewalls are preferably parallel. The ends are preferably parallel. Preferably, the ends connect the sidewalls, preferably such that they form a rectangular or a square. The hollow metal structure preferably has a longitudinal axis, that extends parallel to the longitudinal axis of the structural member of the vehicle. Preferably, one sidewall is parallel to one wall of the structural member of the vehicle and/or one sidewall and/or one or two of the ends are adjacent to the structural member of the vehicle. The ends are preferably parallel to the impact direction, against which protection is sought.

According to the present invention, the hollow metal structure comprises at least one rib each rib having a folding section. Each rib preferably connects two sidewalls of the hollow metal structure. Preferably, each rib is parallel to at least one, preferably both ends of the hollow metal structure. The ribs preferably extend along the longitudinal axis of the hollow metal structure. The folding section is preferably formed as an indentation, preferably a groove or a nut that preferably extends along the longitudinal axis of the hollow metal structure. The indentation preferably has a round shaped cross section, more preferably the shape of a section of a circle. Under the impact load, the ribs will start to fold along the folding section. The folding section has the advantage that the location where each rib starts to fold and the direction into which the rib folds are well defined. With the ribs it can be controlled how the reinforcement member and/or the structural member of the vehicle deform.

Preferably, the folding section is in the center of the extension of the rib between the two sidewalls. However, in case there are more than one rib, this location may be different.

Each rib may be an extruded or a bent or a deep-drawn or a stamped part.

According to a preferred embodiment of the present invention, the hollow metal structure comprises two or more ribs, each preferably extending parallel to the longitudinal direction and/or parallel to each other and/or parallel to the ends of the hollow metal structure and/or perpendicular to the sidewalls and/or connects the side walls.

Preferably the ribs are not equidistantly distributed over the height and/or the z-direction of the hollow metal structure. Preferably, the ribs are provided at a height at which least deformation of the structural member of the vehicle is desired,

Preferably, the folding sections of the ribs have contrarian folding directions, so that during one rib folds in one direction and the other, preferably the adjacent rib folds in the opposite direction. Preferably, two adjacent ribs fold in one direction, while a third rib folds in the opposite direction.

In case there are two or more ribs, the ribs can be made of different materials and/or their thickness may be different. Alternatively or additionally, the design and/or the orientation of the folding section may differ.

In a preferred embodiment, the hollow metal structure has a first- and a second end and at least one end comprises a folding section. Under the impact load, the end will start to fold along the folding section. A rib provided adjacent to this end, has preferably the same folding direction as the end with the folding section.

Preferably, the system further comprising a battery case, which accommodate the batteries, particularly needed for an electric or hybrid vehicle.

According to a preferred embodiment of the present invention, the reinforcement member is located in the structural member of the vehicle such that the 3D-strucutre is facing the expected location of an impact. Preferably, the 3D-strucure is oriented towards the outer periphery of the vehicle. The hollow metal structure is oriented further to the center of the vehicle.

Preferably, the hollow metal structure can at least partially be filled with a 3D-structure and/or a structural foam.

The problem is also solved with a method to absorb energy, particularly impact energy, with the inventive system, wherein the 3D-structure crushes prior to the hollow metal structure.

The disclosure regarding this subject matter also applies to the other subject matters and vice versa. Subject matters disclosed regarding this embodiment of the invention can also be included in other embodiments and vice versa.

This subject matter of the present invention relates to a method to absorb energy, particularly impact energy that occurs during an impact at an automotive vehicle, particularly an electric driven automotive vehicle. The inventive method is particularly suitable to prevent or reduce damage made to a battery case. The inventive method utilizes the inventive system described above.

According to the invention, while the hollow metal structure of the system is crushing, the 3D-structure crushes prior to the hollow metal structure. This embodiment of the present invention has the advantage, that the crushing of 3D-structure absorbs already a significant amount of the impact energy without significantly damaging the hollow metal structure.

Preferably, the hollow metal structure is bending while the composite 3D-structure crushes, more preferably around its longitudinal axis.

Preferably, the hollow metal structure deforms asymmetrically relative to its height or relative to its z-direction. Preferably, the deformation around its middle-height is larger than in the vicinity of the ends.

Preferably, in the region of the hollow metal structure and/or the structural member of the vehicle, in which maximum protection is required, for example the region where the battery case is located, the deformation of the hollow metal structure is less than in its rest. This applies to its longitudinal and/or height-extension.

According to a preferred embodiment of the present invention, in the final stage of the crushing of the composite 3D-structure and/or thereafter, the rib starts to fold.

In case two or mor ribs are provided, the ribs fold at least partially sequentially, differently and/or asymmetrically. Preferably, two ribs towards each other, to that the distance between the two folding sections is reduced. Preferably one rib folds more than the other rib.

Preferably, more than 40%, more preferably than 50%, even more preferably of the total impact energy is absorbed by the composite structure.

Preferably, the highest force in the system occurs after the deformation of the hollow metal structure, particularly the rib(s) has commenced. During the deformation of the 3D-strucutre, the force in the system preferably rises to a peak is then reduced to a plateau, which is below the peak. During the deformation of the hollow metal structure preferably a peak load occurs, which is then reduced to a plateau. Preferably this plateau is lower than the plateau that occurs during the deformation of the 3D-structure.

In the following the inventions are explained according to the figures. These explanations do not limit the scope of protection. The explanations apply to all embodiments of the present invention likewise.

FIG. 1 shows an embodiment of the reinforcement member 1.

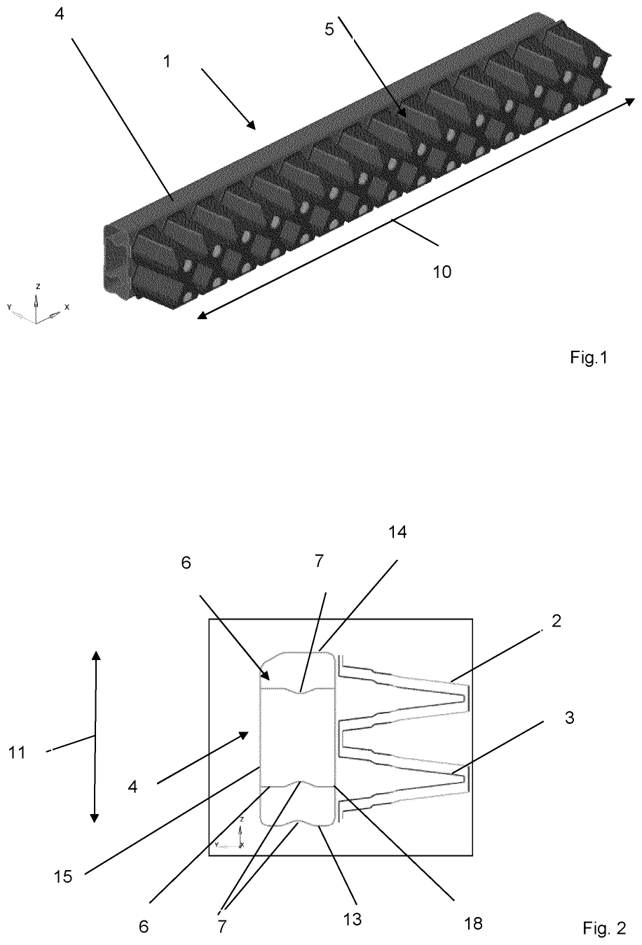

FIG. 2 shows details of the reinforcement member 1.

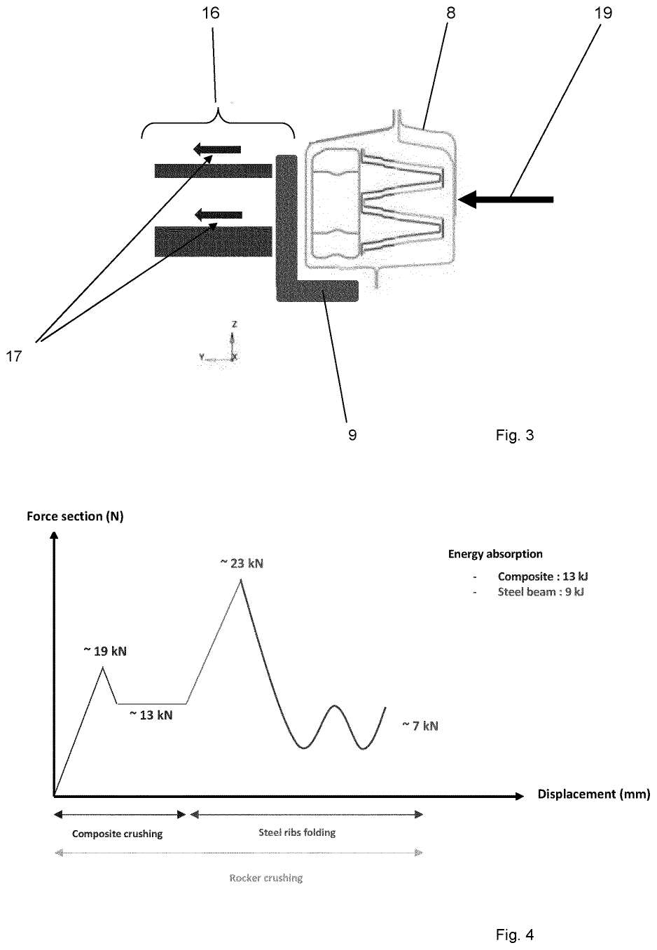

FIG. 3 shows the inventive system.

FIG. 4 shows an example of the load distribution during the deformation of the reinforcement member 1.

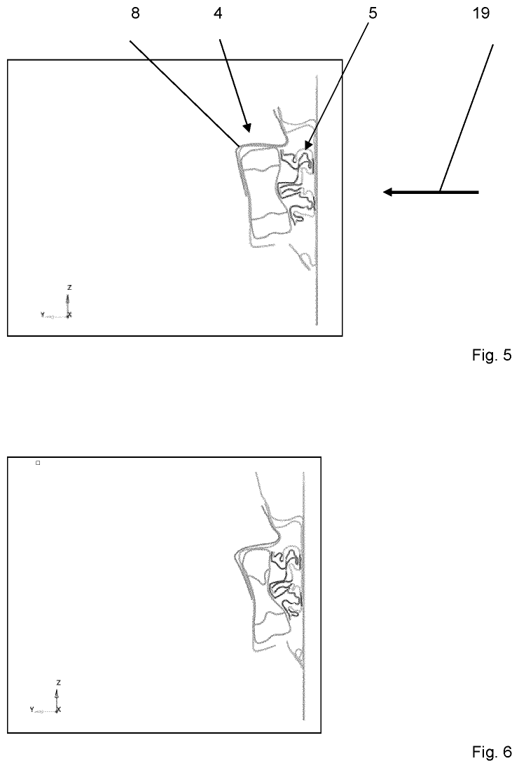

FIGS. 5, 6 show two sequences of the deformation of the inventive system during an impact.

FIG. 1 shows an example of the reinforcement member 1, which comprises a hollow metal structure 4 and a 3D-strucutre 5. The reinforcement member 1 comprises a longitudinal axis 10 and the hollow metal structure and the 3D-strucure preferably extend along the entire longitudinal axis. The longitudinal axis 10 is preferably parallel to the longitudinal axis of a structural member 8 of a vehicle, into which the reinforcement member is inserted. The length of the reinforcement member along the longitudinal axis is preferably chosen according to the partial-or total length of the structural member 8, which shall be reinforced.

FIG. 2 shows detail of the reinforcement member 1. The depiction according to FIG. 2 is a cut perpendicular to the longitudinal axis 10. In the present case, the 3D-strucutre 5 comprises a first- and a second-layer 2, 3. However, the person skilled in the art understands, that one layer or 3, 4, 5 . . . layer(s) may be preferred. Each layer preferably comprises a multitude of three-dimensional elements, in the present case cones, which are connected to each other at a base. In case there are more than one layer, the layer(s) are preferably stacked. This can be achieved by inserting the three-dimensional elements into each other, as it is depicted in FIG. 2. Alternatively or additionally one layer, here layer 3 may comprise openings into which the three dimensional elements of layer 2 are inserted. The layers 2, 3 may connected by an adhesive and/or a form- or a friction-fit. During an impact, the 3D-strucutre is compressed as will be explained in further detail according to the FIGS. 5 and 6. During compression and deformation, the three-dimensional elements of the layers preferably interlock.

The 3D-strucutre 5 is attached to the hollow metal structure for example by mechanical attachment means, but according to a preferred embodiment, the 3D-struutre is glued to the hollow metal structure 4

The hollow metal structure 4 is in the present case designed like a pipe, here with an essentially rectangular cross-section. However, the cross-section may be different, for example square or hexagonal. Preferably, the hollow metal structure 4 has two sidewalls 15, 18, which are preferably parallel and a first- and a second end 13, 14, which are preferably parallel. The hollow metal structure 4 has an extension 11 in the z-direction, which is in the present case the height. Inventively, the hollow metal structure comprises at least one rib 6, in the present case two. Each rib may connect two sidewalls 15, 18. Each rib comprises a folding section 7, here an indentation. During compression of the hollow metal structure 4, each rib starts to collapse at its folding section, as will be explained in further detail according to FIGS. 5 and 6. As can be seen from FIG. 2, the folding section 7 of one rib, here the upper rib, faces in one direction, while the folding section 7 of the other rib, here the lower rib faces in the opposite direction. This mirror-symmetrical orientation of the folding sections has the advantage that the hollow metal structure at least essentially maintains its shape during an impact. Preferably, the ribs are not provided equidistantly along the height 11 of the hollow metal structure, but are distributed along the height-direction to provide minimal deformation in an area where maximum protection of a part, for example the battery case is sought. In the present case the lower rib is provided in at a height of the hollow metal structure adjacent a cross beam of the battery frame, while the upper rib is provided adjacent a cross beam in the vicinity of a passenger seat. In the present case, one end, here the lower end 13 has a folding section 7.

FIG. 2 depicts the inventive system, which comprises a structural member of the vehicle 8, for example a rocker, which is in the present case made od two shells, which are connected along two flanges. The structural member extends along a longitudinal axis. The structural member of the vehicle 8 has a cavity, into which the reinforcement member 1 is placed such that its longitudinal axis is parallel to the longitudinal axis of the structural member of the vehicle 8. The 3D-strucutre 5 of the reinforcement member 1 is preferably directed toward the expected impact direction and/or toward the exterior of the vehicle. The extension of one sidewall 15 of the hollow metal structure in z-direction, preferably essentially corresponds to the extension of the adjacent sidewall of the structural member 8 of the vehicle. The reinforcement member is preferably attached to the structural member of the vehicle 8 with an adhesive and/or a mechanical attachment means. Adjacent to the structural member of the vehicle 8 is in the present example and/or preferably attached thereto is a battery case 9, which accommodates the battery for an electrically driven vehicle. The structural member of the vehicle 8 protects the battery case 9 from an impact as symbolized by the arrow 19. This Figure also depicts that the upper and the lower rib are in line with two cross beams, into which as depicted by arrows 17 the load from an impact is transferred.

Referring now to FIGS. 4-6, the deformation and the load distribution during an impact. After impact, as can be seen from FIG. 5, first the 3D-structure collapse and impact energy is dissipated. The hollow metal structure only deforms slightly. The situation later during the impact is depicted in FIG. 6. After the 3D-structure is completely the hollow metal structure deforms, particularly relative to the z-direction in the middle. The upper rib deforms more than the lower one. In the region where the lower rib is provided the hollow metal structure deforms only very little, so that the battery case is well protected.

FIG. 4 shows a force versus deformation curve. During deformation of the 3D-strucutre, the force rises to a peak, here 19 kN, and then maintains on a plateau, here 13kN. After the the 3D-struture is completely crushed, the force increases to the next peak, here 23 kN, during the deformation of the hollow metal structure and then decreases to a lower plateau, here at 7 kN. More than 50%, here 60%, is absorbed by the 3D-strucutre.

### Reference Signs

1 reinforcement member
2 first layer of the composite structure
3 second layer of the composite structure
4 hollow metal structure
5 3D-structure
6 rib
7 folding section
8 structural member of the vehicle, rocker
9 battery case
10 longitudinal axis, extension in x direction
11 height, extension in z-direction
12 main region of protection
13 one end. Lower end
14 second end, upper end
15 first side wall
16 vehicle component
17 load direction
18 second sidewall
19 impact direction

1. A system comprising:
a structural member of a vehicle and
a reinforcement member inserted into the structural member and comprising a hollow metal structure and a 3D-structure attached to the metal structure,
wherein the hollow metal structure comprises at least one rib each rib having a folding section.

2. The system according to claim 1, wherein the composite 3D-structure comprises at least a first layer and a second layer, each layer comprising a multitude of interconnected three-dimensional elements.

3. The system according to claim 1, wherein the hollow metal structure comprises two or more ribs, each preferably extending parallel to the longitudinal direction and/or parallel to each other.

4. The system according to claim 3, wherein the ribs are not equidistantly distributed over the height and/or the z-direction of the hollow metal structure.

5. The system according to claim 3, wherein each rib connects two sidewalls of the hollow metal structure

6. The system according to claim 3, wherein the folding sections of the ribs have contrarian folding directions.

7. The system according to claim 2, wherein the hollow metal structure has a first- and a second end and at least one end comprises a folding section.

8. The system according to one of the preceding claim 1 further comprising a battery case.

9. A method to absorb energy, impact energy, with, a system according to claim 1, wherein the composite 3D-structure crushes prior to the hollow metal structure.

10. The Method according to claim 9, the hollow metal structure is bending while the composite 3D-structure crushes.

11. The method according to claim 9, wherein the final stage of the crushing of the composite 3D-structure and/or thereafter, the rib folds.

12. The method according to claim 9, wherein case two or more ribs are provided, the ribs fold at least partially sequentially and/or asymmetrically.

13. The method according to claim 9, the more than 40%, preferably more than 50% of the total impact energy is taken up by the composite structure.

14. The system according to claim 2, wherein during compression and deformation, the three-dimensional elements of the layers interlock.

15. The system according to claim 2, wherein the three-dimensional elements are glued to the hollow metal structure.

16. The system according to claim 15, wherein the hollow metal structure has a rectangular cross-section.

17. The system according to claim 15, wherein the three-dimensional elements are formed as cones connected to one another at a base.

18. The system according to claim 15, wherein one or more three-dimensional elements include openings for receiving portions of other three-dimensional elements.

19. The system according to claim 2, wherein an adhesive connects one or more three-dimensional elements to additional three-dimensional elements.

20. The system according to claim 16, wherein the structural member is a vehicle rocker and comprises first and second shells so that the hollow metal structure is located substantially within the first shell and the three-dimensional elements are located substantially within the second shell.
